(19) United States
(12) Patent Application Publication
(10) Pub. No.: US 2019/0199671 A1
(43) Pub. Date: Jun. 27, 2019

(54) AD-HOC VIRTUAL ORGANIZATION COMMUNICATION PLATFORM

(71) Applicant: Knowmail S.A.L LTD., Tikva (IL)

(72) Inventors: Oded Avital, Ganey Tiqua (IL); Avi Mandelberg, Hod Ha'Sharon (IL); Yury Gubman, Jerusalem (IL); Shmuel Ur, Shorashim (IL)

(21) Appl. No.: 15/855,558

(22) Filed: Dec. 27, 2017

(51) Int. Cl. H04L 12/58

(52) U.S. Cl. CPC H04L 51/22; G06Q 10/107; H04L 51/14; H04L 51/16

(57) ABSTRACT

A communication platform for ad-hoc virtual organization. An ad-hoc virtual organization that comprises a plurality of users, at least two of which utilize different and unaffiliated message servers for handling their communication messages, is determined. Communication messages of the plurality of users are obtained, wherein the communication messages comprise all communication messages determined to be related to the ad-hoc virtual organization. The communication messages are processed to determine aggregated data. At least a portion of the aggregated data is transmitted to a client of the user, whereby the client is enabled to utilize the aggregated data to improve user experience of the user using information obtained from other users.

### TECHNICAL FIELD

The present disclosure relates to communication systems in general, and to scoring communication messages, in particular.

### BACKGROUND

Electronic-based communication message, such as e-mails, instant messages, Short Message Service (SMS) messages, Whatsapp™ messages, Facebook™ private messages, or the like, is a method of exchanging digital messages from an author to one or more recipients. E-mail is a prominent example of such communication system, which is referred to be herein as an example of a communication system.

Current communication message systems are mostly client-server based. A message server is an application that receives communication messages from message clients, or from other message servers. A message server usually comprises a list of users, a storage area, a set of user definable rules, and a series of communication modules. The storage area is where received messages are stored for local users, and where messages in transit to another destination are temporarily stored. It usually takes the form of a database of information. The user defined rules determine how the message server should react when determining the destination of a specific message, or possibly react to the sender of the message. For example: specific e-mail addresses can be barred, or certain users can be restricted to only sending messages within the company. The list of users is a database of user accounts that the mail server recognizes and will deal with locally, and the communications modules are components that actually handle the transfer of messages to and from other mail servers and e-mail clients. Depending upon the requirements of the message server, a number of different modules may be installed and used by the server.

A message client is an application, used by users for reading, writing, sending and receiving communication messages. A message client may be installed on a user's computing platform, but may additionally or alternatively be implemented as a web page accessed for example using a browser. The client usually comprises an editor, an address book, a folder collection or hierarchy in which messages may be stored, and communications modules. The address book allows users to store commonly used addresses in an easy to get at format, reducing the chance of addressing errors.

In normal operation mode, a client composes a message addressed to one or more addressees. Zero, one or more of the addressees may be from the same organization, i.e., connected to the same mail server, and zero, one or more may be external to the organization. After composing the message, it is being sent and distributed by the message server to the internal addressees, if any, or to one or more external message servers for distribution to the external addressees, if any.

Also in normal operation mode, a client receives messages from users within the organization or external to the organization. The user may view the received or sent messages, and may order them in accordance with predetermined parameters, such as receipt date and time, sender, subject, or the like. In some cases, computed parameter, such as “IS SPAM” parameter, or “IS IMPORTANT” parameter, may be computed when the e-mail is received and used for sorting or filtering of the e-mails.

### BRIEF SUMMARY

One exemplary embodiment of the disclosed subject matter is a computer program product comprising a non-transitory computer readable storage medium retaining program instructions, which program instructions when read by a processor, cause the processor to perform a method comprising: determining an ad-hoc virtual organization, wherein the ad-hoc virtual organization comprises a plurality of users, wherein at least two users utilize different and unaffiliated message servers for handling their communication messages; obtaining communication messages of the plurality of users, wherein said obtaining comprises obtaining for a user, a proper subset of communication messages transmitted to the user, wherein the proper subset comprises all communication messages determined to be related to the ad-hoc virtual organization; processing the communication messages of the plurality of users to determine aggregated data; and transmitting to a client of the user, at least a portion of the aggregated data, whereby the client is enabled to utilize the aggregated data to improve user experience of the user using information obtained from other users.

Optionally, said processing comprises determining a predictive model based on activity of the plurality of users with respect to the communication messages, wherein said transmitting comprises transmitting the predictive model, whereby the client is enabled to utilize the predictive model in making predictions for the communication messages.

Optionally, said making predictions is selected from one of the following: predicting scores for communication messages, predicting important messages; predicting spam messages; and predicting action to be taken by the user for the communication messages.

Optionally, said processing comprises determining an aggregated address book for the ad-hoc virtual organization, and whereby the client is provided with the aggregated address book which includes addresses not used by the user and used by other users of the ad-hoc virtual organization.

Optionally, for each user, communication messages determined to be related to the ad-hoc virtual organization, is determined based on user indication.

Optionally, for each user, communication messages determined to be related to the ad-hoc virtual organization, is determined based on a user-defined automated rule.

Optionally, the user-defined automated rules comprises on of the following: a rule about a subject of a communication message; a rule about a topic of a communication message; and a rule about addressees or authors of a communication message.

Optionally, for each user, communication messages determined to be related to the ad-hoc virtual organization, is determined based on automated determination based on similarity to a set of communication messages that are a-priori known to be related to the ad-hoc virtual organization.

Optionally, the user is part of the ad-hoc virtual organization and of a second ad-hoc virtual organization.

Optionally, the aggregated data is utilized with respect to communication messages that are related to the ad-hoc virtual organization.

Optionally, a first communication message is related solely to the ad-hoc virtual organization, wherein a second communication message is related solely to the second ad-hoc virtual organization, and wherein a third communication message is related to both the ad-hoc virtual organization and the second ad-hoc virtual organization.

In some cases, a computerized apparatus comprising a processor and a memory, said memory retaining a computer program product according the disclosed subject matter.

Another exemplary embodiment of the disclosed subject matter is a method comprising: determining an ad-hoc virtual organization, wherein the ad-hoc virtual organization comprises a plurality of users, wherein at least two users utilize different and unaffiliated message servers for handling their communication messages; obtaining communication messages of the plurality of users, wherein said obtaining comprises obtaining for a user, a proper subset of communication messages transmitted to the user, wherein the proper subset comprises all communication messages determined to be related to the ad-hoc virtual organization; processing the communication messages of the plurality of users to determine aggregated data; and transmitting to a client of the user, at least a portion of the aggregated data, whereby the client is enabled to utilize the aggregated data to improve user experience of the user using information obtained from other users.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows an illustration of a computerized environment, in accordance with the disclosed subject matter;

FIG. 2A shows a flowchart diagram of a method, in accordance with some exemplary embodiments of the disclosed subject matter; and

FIG. 2B shows a flowchart diagram of a method, in accordance with some exemplary embodiments of the disclosed subject matter.

### DETAILED DESCRIPTION

In the description below, the terms “mail”, “e-mail”, “email”, “message”, “communication” or “communication message” are used interchangeably and refers to an electronic communication message that may be transmitted by an author to one or more intended recipients and may be consequently received by devices of such recipients. The term should be construed to exclude broadcasted messages, such as posts in a bulletin board, posts in a social network, or the like, which are not designated to a specific user or group of users, and which can be viewed by users who the message was not originally intended to. The term is not limited to any specific protocol. Exemplary protocols for transmitting such messages may include Simple Mail Transfer Protocol (SMTP), Post Office Protocol (POP3), Internet Message Access Protocol (IMAP), Short Message Service (SMS) or the like.

One technical problem dealt with by the disclosed subject matter is to provide benefits of having an organizational server in cases where no such server exists. In some cases, benefits of using a same server may be implicit sharing of information between different users. Such information may be useful for the server to provide automated rules, provide computed priority scores, or the like, which may be used by the clients. Additionally or alternatively, information regarding on who is doing what in response to the communications and detecting effectiveness of messages may also be extrapolated from the information and used. As an example, a suggestion as to which communication method, timing, content is predicted to be effective on a specific target can be provided to the user. In some cases, some information may be collected and used by other clients, such as an organizational address book.

One technical solution is to create ad-hoc virtual organization of users. Users may authorize the sharing of information with a centralized entity, which may process the information and aggregate it. The shared information may be restricted to information relevant for the ad-hoc virtual organization, such as information relating to communication messages that are considered relevant to the ad-hoc virtual organization.

The aggregated data may be used to improve the user experience of members of the ad-hoc virtual organization. In some exemplary embodiments, the aggregated data may be used to provide an organizational address book which can be used by members of the ad-hoc virtual organization. The address book may include addresses of recipients of messages issued by the members of the ad-hoc virtual organization and in relation thereto. The address book may include address of senders of messages sent to members of the ad-hoc virtual organization and in relation thereto. In some exemplary embodiments, the aggregated data may be used to train a predictive model to be used to improve the user experience. In some cases, the predictive model may be used by a client to determine whether a message is SPAM or not, whether a message is important or not, a priority of a message, a score used for ordering the message, a suggested action to be taken in response to the message, or the like. The predictive model may be trained using communication messages gathered from various clients of users that are member of the ad-hoc virtual organization. Additionally or alternatively, the predictive model may be used to predict potential outcome of sending a particular message to a specific target. In some cases, the prediction may be used to improve the communication message to be more effective, such as by suggesting modifications to its content, to the communication channel being used (e.g., e-mail instead of SMS), changing transmission time (to 5 pm, not on the 15^{th} of the month, etc.), or the like.

In some exemplary embodiments, one user may be a member of several organizations. A first portion of the user's inbox may be associated with a first organization, a second portion of the user's inbox may be associated with a second organization and so forth. The portions may be proper subset of the inbox and may not include all the communication messages. In some cases, a same communication message may be associated with more than one organization. In some exemplary embodiments, the same communication message may be split into portions, such that a first portion, e.g., first three paragraphs, may be associated with one organization, while a second portion, e.g., the fourth paragraph, may be associated with another organization. In accordance with the disclosed subject matter, the communication message may be partitioned into basic blocks, where each block may be considered as a separate communication, thereby providing different scoring, rules, association, or the like, to different portions of the same communication message.

In some exemplary embodiments, the disclosed subject matter may be employed where two or more users may use the services of a different message server. As an example, one user may use an organizational e-mail server of his company. A second user may use an e-mail server provided by her Internet Service Provider (ISP). A third user may use an e-mail server of a web-based service, such as GMAIL™ or HOTMAIL™. Although the users do not use the same server, the disclosed subject matter may be employed and provide for centralized processing of messages that are retained on different servers and that otherwise would not be available on the same platform.

In some exemplary embodiments, a communication message may be tagged, labeled or otherwise marked as being associated with an ad-hoc virtual organization. The marking may be performed manually by the user who may explicitly mark each communication message that is associated with an ad-hoc virtual organization. Additionally or alternatively, automated rules may be defined to automatically mark communication messages with ad-hoc organizations. The rules may be based on the sender, the recipient, the title of the communication message, a summarized topic thereof (e.g., using topic summarization), or the like. In some exemplary embodiments, a communication message that is an outcome of an action regarding a previous message that is associated with the ad-hoc virtual organization. As an example, performing “reply” to a message associated with the organization create a new message that is also associated with the same organization. As another example, forwarding a message associated with the organization may result in a new message that is also associated with the organization. In some cases, such conditions may not be conclusive as to the association of the new message to the organization but may be used to increase likelihood of the new message to be associated with the organization. In some exemplary embodiments, look-a-like techniques may be employed to use an example set of communication messages to automatically define rules for identifying communication messages associated with the ad-hoc virtual organization. Similar messages thereto may be automatically marked, such as based on their metadata, their content, or the like. Additionally or alternatively, Natural Language Processing (NLP) techniques may be employed to process the communication messages and determine whether it is similar to other messages already marked, such as using supervised learning. Additionally or alternatively, deep learning techniques, such as Artificial neural networks (ANNs), deep neural networks (DNNs), or the like, may be employed to automatically identify messages relating to the ad-hoc virtual organization. In some exemplary embodiments, the marking rules or training set used to define the marking rules may also be shared among the members of the ad-hoc virtual organization, enabling the automated associated of communication messages relating to the organization based on the cumulative data from members thereof.

In some exemplary embodiments, the ad-hoc virtual organization may provide a communication association tool. The communication association tool may be configured to associate in a client, messages that are associated with the organization. In some exemplary embodiments, the communication association tool may be configured to utilize shared rules, manually defined rules, prediction models, clustering techniques, or the like, to identify which of the communication messages in the client is associated with the ad-hoc virtual organization. In some cases, the tool may forward such communication messages to the server. Additionally or alternatively, the tool may allow the user to view the messages that are being forwarded and approve such process. The user may thus review and ensure the tool filters the correct subset that is indeed associated with the ad-hoc virtual organization. In some cases, once the user is confident the tool does not infringe its privacy and only forwards the correct messages, the user may allow the tool to forward the messages without her approval. In some exemplary embodiments, the tool may be a computer executable file, or a configuration file to affect the operation of the client, an add-on to the client, or the like.

One technical effect of the disclosed subject matter is to provide users with flexible memberships of organizations for the purpose of communication messages. A user need not migrate to a different server in order to join an organization and the disclosed subject matter may be used to decouple the organizational membership from the message server used by the user. In some cases, the user may be able to join several different ad-hoc organization and enjoy the benefit of a centralized server even though, each user uses a potentially different communication service and different message server. Additionally or alternatively, the user is enabled to selectively associate her messages to the organization, enabling her to select which of her communication messages (e.g., in her inbox, sent items, or the like) is actually associated with the organization. This may be helpful in protecting the user's privacy and preventing an organization from viewing her private messages or messages associated with a different organization, while still enabling the user to enjoy, in a single client and a single inbox, the benefits of having cumulative organizational knowledge.

The disclosed subject matter may provide for one or more technical improvements over any pre-existing technique and any technique that has previously become routine or conventional in the art.

Additional technical problem, solution and effects may be apparent to a person of ordinary skill in the art in view of the present disclosure.

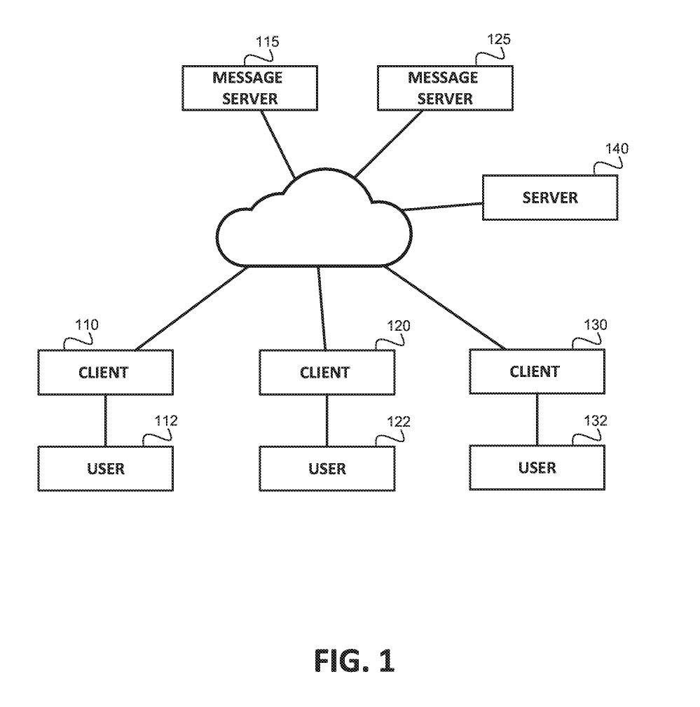

Referring now to FIG. 1, showing an illustration of a computerized environment, in accordance with the disclosed subject matter.

Client 110 is a message client, such as an e-mail client. Client 110 is used by a User 112. Message Server 115 is used by Client 110 to retain and transfer messages to and from Client 110. Similarly, Client 120 of User 122 uses Message Server 125. Client 130 of User 132 is also shown and is connected to Message Server 125. Additional clients may also utilize the same or other servers. However, for clarity of the description, FIG. 1 uses the example of two servers and three clients. The disclosed subject matter is not limited to such a configuration.

In some exemplary embodiments, Users 112, 122 may be members of a same ad-hoc virtual organization. Messages associated with that organization may be transmitted to from Clients 110 and 120 to Server 140 for processing. In some cases, Server 140 may be executed by the same machine that executes one of Servers 115, 125. In other cases, Server 140 may be executed by the same machine that executes one of Clients 110, 120. In yet other cases, a dedicated machine may be used to execute Server 140, such as a cloud computing server. In some cases, the messages that are transmitted by be a proper subset of the messages of the Users 112, 122.

The ad-hoc virtual organization may be for example, related to a projected that people from multiple companies take part in. In such a case, only communication messages related to the project are shared with Server 140 for the ad-hoc virtual organization. Customers of a product or service may form an ad-hoc virtual organization, which covers only communication messages related to the product or service. An ad-hoc virtual organization may be formed for the nuclear family, in which all communication messages of the user may be considered part of the organization. In some cases, business communications or communications otherwise belonging to a different organization, such as the user's workplace, may be excluded and not shared. Yet another example of an ad-hoc virtual organization may be the extended family of the user, and such organization may be cover communication messages relating to meetings therebetween and food to bring to such meetings. Yet another example may be a bike club. In such a case, all communications related to biking are considered as part of the organization as well as communications to and from members of the bike club. As another example, an Non-Governmental Organization (NGO) may have volunteers, each with his own private e-mail account. The disclosed subject matter may be utilized to identify all such vulnerates and cover in the ad-hoc virtual organization of the NGO all communication messages that include NGO related information.

In some exemplary embodiments, Users 112, 132 may be members of a second ad-hoc virtual organization. Messages associated with the second ad-hoc virtual organization may be transmitted to Server 140 for processing. Hence, aggregated data produced with respect to each organization may be different, even for the same users (e.g., User 112).

The aggregated data produced by Server 140 with respect to an ad-hoc virtual organization may be provided to clients of the members of the organization, such as Clients 110 and 120, and used thereby to improve the user experience of their users. In some cases, an organizational address book may be provided and used. The organizational address book may assist the user in providing a meaningful name to addresses, and in locating the address of potential recipients, even such recipients to which the user has never before sent a message. In some exemplary embodiments, a predictive model may be generated for the organization and provided to the client to be used thereby. In some cases, the predictive model may be modified to be user-tailored, such as based on the user's action. For example, a general organizational model may be generated and then modified to better be suited to the user herself.

Clients 110, 120, 130 may be executed by a personal computer, a mobile device, a laptop computer, a desktop computer, a tablet computer, a computerized device, or the like. Servers 115, 125 and Server 140 may be executed by a computerized device, a computer server, a cloud computing platform, a computer, or the like.

In some exemplary embodiments, Servers 115 and 125 may be unaware of the role of Server 140 and may only communicate with their respective clients. The clients may be in charge to transmit the information to Server 140, thereby enabling the utilization of the disclosed subject matter in a manner that is transparent to the message servers and without affecting their performance.

In an alternative embodiment, Servers 115 and 125 may take an active role with respect to the ad-hoc virtual organization. Servers 115 and 125 may transmit to Server 140 the information relating to the ad-hoc virtual organization themselves. For example, Server 115 may receive an indication from Client 110 which of the messages of Client 110 are associated with the ad-hoc virtual organization, and may transmit such messages to Server 140. Additionally or alternatively, Server 115 may detect associated messages itself, such as based on user-provided rule, based on automatically defined rule, using clustering, or using other automated machine learning based technique. In such an embodiment, the performance of the client is not affected by the utilization of the disclosed subject matter and as the server may typically have more resources, such as better bandwidth, than the client, the overall performance of the system is improved.

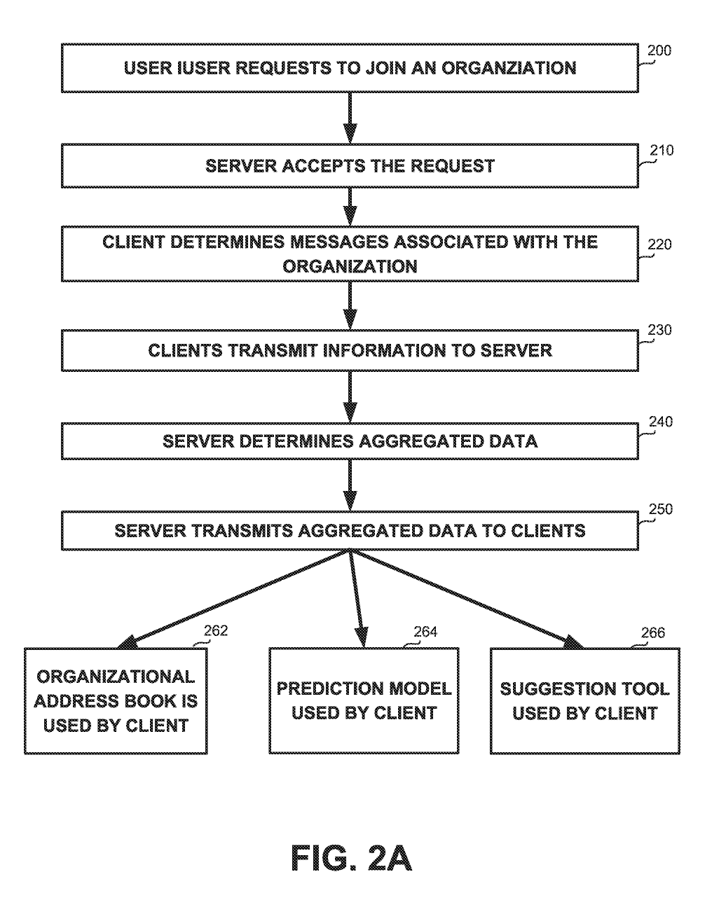

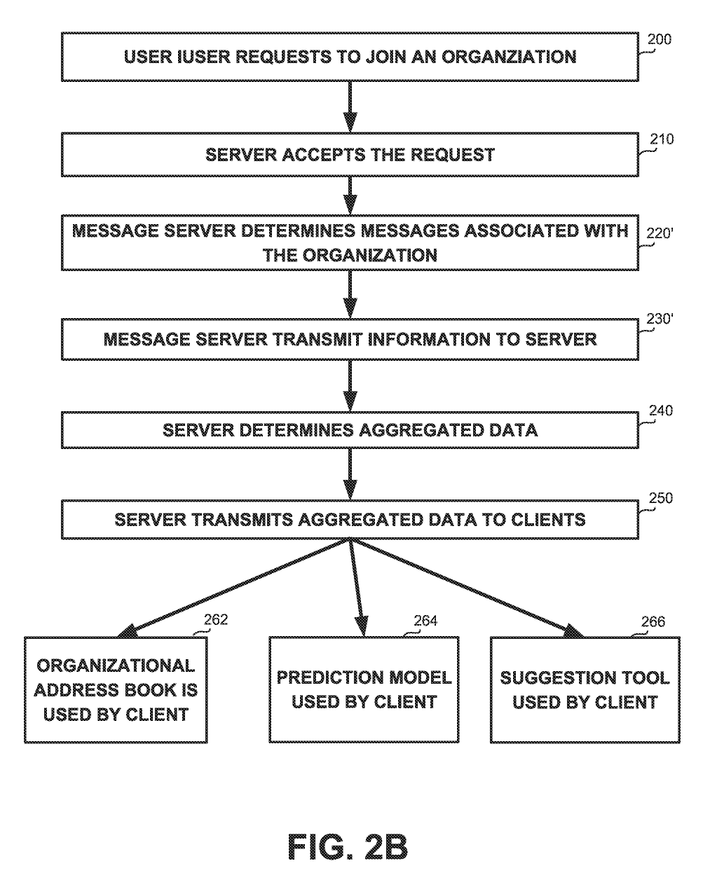

Referring now to FIG. 2A, showing a flowchart diagram of a method, in accordance with some embodiments of the disclosed subject matter.

On Step 200, a user indicates that she is a member of an ad-hoc virtual organization. The user may manually indicate her membership. In some cases, the user may be prompted by the client that verify she is a member of an organization, based on communication messages she receives and/or sends.

On Step 210, a server in charge of administrating the ad-hoc virtual organization receives a request to add the user to the ad-hoc virtual organization. The server may verify the user is authorized to join, such as by prompting a human administrator to approve or reject the request. Additionally or alternatively, the server may determine whether or not to accept the request based on predetermined rules, such as relating to permissions, based on naming conventions, or the like.

On Step 220, the client may determine which communication messages of the user are associated with the ad-hoc virtual organization. The client may determine such association based on explicit user indication, such as the user marking the associated messages. The client may determine the association based on explicit user rules, such as the user may define a regular expression which, when matched in the subject line of an e-mail, indicates the e-mail is associated with the ad-hoc virtual organization. The user may determine rules based on the content of the messages, metadata thereof, such as sender, recipients, timestamp, or the like, and the like. In some exemplary embodiments, the determination may be based on similarity to previously identified messages. Messages may be converted into feature vector and clustering may be used to identify clusters of similar messages. In some cases, a cluster associated with the ad-hoc virtual organization may be determined based on the messages of the user herself alone. Additionally or alternatively, the cluster may be identified based on the messages of the organization itself, including messages obtained from other clients and not relating to the user. In some exemplary embodiments, a predictive model may be determined to automatically identify messages relating to the organization. The user may manually override such determinations, if she so wishes.

On Step 230, clients of users that are members of the ad-hoc virtual organization transmit information to the server. The clients may transmit all relevant information at the beginning and may periodically update the information in an incremental manner. The clients may alternatively send continuous updates as the are identified in the client. The information transmitted may include the communication messages. In some cases, the communication messages may be sent as is. Additionally or alternatively, the communication messages may be translated into a feature vector and the feature vector may be sent. Additionally or alternatively, the communication messages may be anonymized before being transmitted. In some cases, each client may create a predictive model using the communication messages and the predictive model itself may be transmitted instead of transmitting the messages. Such an embodiment may reduce the risk of information leaking, while still enabling the creation of an aggregated predictive model. Similarly, each client may compile an address book relevant for the ad-hoc virtual organization and transmit such address book. In some exemplary embodiments, the information transmitted may include the communication messages and metadata associated thereto, such as actions taken by the user in response to the message, time taken to the user to perform the action, or the like.

On Step 240, the server processes the communication messages received from various clients. The processing may be performed so as to determine aggregated data. The aggregated data may be, for example, an organizational address book, a prediction model relating to the organization, or the like.

On Step 250, the aggregated data may be transmitted to the clients of the users who are members of the ad-hoc virtual organization. The aggregated data may be shared with such clients to be used with respect to communication messages that are associated with the ad-hoc virtual organization.

On Step 262, an organizational address book is used by client to allow user to select address of a recipient when composing a new communication message that is associated with the ad-hoc virtual organization. The association with the organization may be determined based on the content of the message being composed, based on the message on top which the message is being composed, based on explicit user determination, or the like. Additionally or alternatively, communication messages transmitted to the user or by the user may be displayed, while showing instead of or in addition to a crude address a name associated with the address, as indicated in the organizational address book.

On Step 264, a prediction model may be used by the client. The prediction model may be used to score communication messages associated with the organization, in accordance with their importance, urgency, or the like, as is disclosed in view of the activity of the user and other users relating to communication messages of the same ad-hoc virtual organization. It will be noted that for one user, a first model may be used to score a first portion of the messages, while a second model may be used to score a second portion of the messages. In some cases, a message may appear in both portions and may be scored based on an aggregation of the two scores, such as by setting the maximal value between the two scores, by setting an average value of the two scores, or the like. In some cases, the user may select an organizational view and request to view only communication messages relating to one ad-hoc virtual organization. In such a case, the score of the message may be the one determined with respect to the selected ad-hoc virtual organization.

Additionally or alternatively, the prediction model may be used to label a message as SPAM, important, or another label, based on the labeling performed by other users of the organization with respect to messages associated with the organization.

On Step 266, a suggestion tool may be used by a client to provide the user with suggestions or insights that are based on the information collected by the ad-hoc virtual organization. In some cases, the suggestion tool may provide a suggested modification to a communication message the user wishes to send to a target recipient so as to increase the effectiveness of the message. The suggestion may be based on the history the organization has for the target recipient, from which it can be deduced that the recipient is more likely to respond to a message on a different time, if received via a different channel, if content is re-written to be longer or shorter, if content has different sentiment, or the like.

Additionally or alternatively, the suggestion tool may be configured to utilize the organizational address book together with contextual information to provide suggested completion or modification to the list of recipients, such as do not forget to add Bob, and is this the right Bob? The suggestion too may heuristically choose the suggested recipient from a plurality of potential recipients in the organizational address book, such as selecting the correct “John” from a list, based on the content of the message, based on the other recipients, or the like. The context information may be information gathered from all members of the ad-hoc virtual organization, and may not be limited to the activity of the user herself.

Referring now to FIG. 2B, showing a flowchart diagram of a method, in accordance with some embodiments of the disclosed subject matter. In FIG. 2B, the message server serving the client, such as the e-mail server in which the email messages of the user are stored, may directly assess which message is associated with the organization (Step 220′). The message server may transmit the communication messages to the server (Step 230′). In such a case, the client may not be the one performing one or more of these tasks.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer program product comprising a non-transitory computer readable storage medium retaining program instructions, which program instructions when read by a processor, cause the processor to perform a method comprising:
determining an ad-hoc virtual organization, wherein the ad-hoc virtual organization comprises a plurality of users, wherein at least two users utilize different and unaffiliated message servers for handling their communication messages;
obtaining communication messages of the plurality of users, wherein said obtaining comprises obtaining for a user, a proper subset of communication messages transmitted to the user, wherein the proper subset comprises all communication messages determined to be related to the ad-hoc virtual organization;
processing the communication messages of the plurality of users to determine aggregated data; and
transmitting to a client of the user, at least a portion of the aggregated data, whereby the client is enabled to utilize the aggregated data to improve user experience of the user using information obtained from other users.

2. The computer program product of claim 1, wherein said processing comprises determining a predictive model based on activity of the plurality of users with respect to the communication messages, wherein said transmitting comprises transmitting the predictive model, whereby the client is enabled to utilize the predictive model in making predictions for the communication messages.

3. The computer program product of claim 2, wherein said making predictions is selected from one of the following: predicting scores for communication messages, predicting important messages; predicting spam messages; and predicting action to be taken by the user for the communication messages.

4. The computer program product of claim 1, wherein said processing comprises determining an aggregated address book for the ad-hoc virtual organization, and whereby the client is provided with the aggregated address book which includes addresses not used by the user and used by other users of the ad-hoc virtual organization.

5. The computer program product of claim 1, wherein for each user, communication messages determined to be related to the ad-hoc virtual organization, is determined based on user indication.

6. The computer program product of claim 1, wherein for each user, communication messages determined to be related to the ad-hoc virtual organization, is determined based on a user-defined automated rule.

7. The computer program product of claim 6, wherein the user-defined automated rules comprises on of the following:
a rule about a subject of a communication message;
a rule about a topic of a communication message; and
a rule about addressees or authors of a communication message.

8. The computer program product of claim 1, wherein for each user, communication messages determined to be related to the ad-hoc virtual organization, is determined based on automated determination based on similarity to a set of communication messages that are a-priori known to be related to the ad-hoc virtual organization.

9. The computer program product of claim 1, wherein the user is part of the ad-hoc virtual organization and of a second ad-hoc virtual organization.

10. The computer program product of claim 9, wherein the aggregated data is utilized with respect to communication messages that are related to the ad-hoc virtual organization.

11. The computer program product of claim 9, wherein a first communication message is related solely to the ad-hoc virtual organization, wherein a second communication message is related solely to the second ad-hoc virtual organization, and wherein a third communication message is related to both the ad-hoc virtual organization and the second ad-hoc virtual organization.

12. A computerized apparatus comprising said processor and a memory, said memory retaining the computer program product of claim 1.

13. A method comprising:
determining an ad-hoc virtual organization, wherein the ad-hoc virtual organization comprises a plurality of users, wherein at least two users utilize different and unaffiliated message servers for handling their communication messages;
obtaining communication messages of the plurality of users, wherein said obtaining comprises obtaining for a user, a proper subset of communication messages transmitted to the user, wherein the proper subset comprises all communication messages determined to be related to the ad-hoc virtual organization;
processing the communication messages of the plurality of users to determine aggregated data; and
transmitting to a client of the user, at least a portion of the aggregated data, whereby the client is enabled to utilize the aggregated data to improve user experience of the user using information obtained from other users.

14. The method of claim 13, wherein said processing comprises determining a predictive model based on activity of the plurality of users with respect to the communication messages, wherein said transmitting comprises transmitting the predictive model, whereby the client is enabled to utilize the predictive model in making predictions for the communication messages.

15. The method of claim 14, wherein said making predictions is selected from one of the following: predicting scores for communication messages, predicting important messages; predicting spam messages; and predicting action to be taken by the user for the communication messages.

16. The method of claim 13, wherein said processing comprises determining an aggregated address book for the ad-hoc virtual organization, and whereby the client is provided with the aggregated address book which includes addresses not used by the user and used by other users of the ad-hoc virtual organization.

17. The method of claim 13, wherein for each user, communication messages determined to be related to the ad-hoc virtual organization, is determined based on user indication or based on a user-defined rule.

18. The method of claim 13, wherein for each user, communication messages determined to be related to the ad-hoc virtual organization, is determined based on automated determination based on similarity to a set of communication messages that are a-priori known to be related to the ad-hoc virtual organization.
